(19) United States
(12) Patent Application Publication
(10) Pub. No.: US 2006/0056344 A1
(43) Pub. Date: Mar. 16, 2006

(54) Seamless channel change in a wireless local area network

(75) Inventors: Vincent Roy, Montreal (CA); Paul Marinier, Brossard (CA); Christopher Cave, Candiac (CA); Angelo Cuffaro, Laval (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/005,823

(22) Filed: Dec. 7, 2004

Related U.S. Application Data
(60) Provisional application No. 60/608,769, filed on Sep. 10, 2004.

(51) Int. Cl. H04Q 7/00

(52) U.S. Cl. 370/329; 370/338

(57) ABSTRACT

A method for seamless channel change in a wireless local area network having a station (STA) and an access point (AP) begins by sending a channel change intention message from the AP to the STA. A channel change response message is sent from the STA to the AP, informing the AP whether the STA will follow the channel change. The AP determines whether to proceed with the channel change, and performs the channel change if the determination is positive.

### CROSS REFERENCE TO RELATED APPLICATION

This application claims the benefit of U.S. Provisional Application No. 60/608,769, filed Sep. 10, 2004, which is incorporated by reference as if fully set forth herein.

### FIELD OF INVENTION

The present invention generally relates to a wireless local area network (WLAN), and more particularly relates to a method for seamless channel change in a WLAN.

### BACKGROUND

In a WLAN system operating in infrastructure mode, an access point (AP) associated to a basic service set (BSS) typically has one or more stations (STAs) associated with it. The AP and its associated STAs communicate with each other by sending and receiving packets over a given channel. When this channel is congested (i.e., the offered traffic on the channel is high), it can be desirable for the nodes of the BSS to use a less-congested channel. Similarly, if the channel is affected by interference external to the system, which is not uncommon in unlicensed bands, it may also be desirable and even necessary for the nodes of the BSS to use a different channel.

The typical way by which BSSs change channels is for the AP to change the channel on which it transmits all of its frames (management, control, and data) at a specific instant. This means that a STA would suddenly stop receiving any frames from its AP and would see all the frames it sends to the AP remain unacknowledged. For Quality-of-Service (QoS)-sensitive services, this service discontinuity translates into unsatisfied users.

An amendment (IEEE 802.11h) was made to the WLAN Medium Access Control (MAC) and Physical Layer (PHY) specifications in order to satisfy regulatory requirements for operation in the 5 GHz band in Europe. The amendment is meant to allow WLAN systems in the 5 GHz band to co-exist with radar systems, but it does not provide the means by which channel changes can be performed in a manner that is seamless to the end-users and that ensures efficient use of the radio resources. The family of 802.11 standards does not provide any form of hand-shaking that ensures a seamless channel change when the AP or the STA decides to change its channel.

For a system operating in infrastructure mode, the 802.11h specification includes a notification message allowing the AP to notify the STA that it will be switching channels in the future. Three options allow the notification to qualify, at a high level, when the channel switch will occur. It is noted that the prior art does not provide any mechanisms for the following:

1) The STA to request the AP to change the channel.

2) The STA to acknowledge that it has received the notification from the AP and that it will follow the AP to the new channel. In 802.11h, the notification is performed using a broadcast, so the AP does not receive any acknowledgement (ACK) allowing it to determine if the STA will follow it to the new channel or if the STA correctly received the notification. This can create a situation where an AP needlessly transmits and retransmits frames to a STA that did not follow the AP to the new channel. The number of frames buffered in the AP can be substantial and could lead to a dramatic inefficiency of the wireless medium due to the exponentially increasing back off window associated with multiple retransmissions.

3) The STA to acknowledge that it has followed the AP to the new channel. This can create a similar inefficiency situation as described above.

Accordingly, a need exists for a method and apparatus for seamless channel change in a WLAN.

### SUMMARY

The present invention addresses the limitations of the prior art, thus allowing a seamless channel change in a WLAN without service interruption and without dramatic reduction of the efficiency of the wireless medium.

A method for seamless channel change in a WLAN having a STA and an AP begins by sending a channel change intention message from the AP to the STA. A channel change response message is sent from the STA to the AP, informing the AP whether or not the STA will follow the channel change. The AP determines whether to proceed with the channel change, and performs the channel change if the determination is positive.

Another method for seamless channel change in a WLAN having a STA and an AP begins by sending a channel change request message from the STA to the AP. A determination is made whether the channel change can be performed, and the channel change is performed based on the determination.

An optional additional step for both of these methods includes sending a channel change executed message from the STA to the AP upon successful execution of the channel change.

A system for performing a seamless channel change in a wireless local area network includes an access point (AP) and a station (STA). The AP is configured to send a channel change intention message to the STA. The STA is configured to send a channel change response message to the AP, including an indication whether the STA will follow the AP to a new channel. After receiving the channel change response message, the AP is further configured to determine whether or not it will proceed with the channel change and to perform the channel change if the determination is positive. Although the AP will consider the response message from the STA, the decision whether to proceed with the channel change does not need to be in accordance with the response message.

Another embodiment of a system for performing a seamless channel change in a wireless local area network (WLAN) includes an access point (AP) and a station (STA). The STA is configured to send a channel change request message to the AP. In the case where the AP only supports one STA, the AP is configured to determine whether the channel change can be performed, and to perform the channel change based on the determination. In the case where the AP supports more than one STA, the AP is configured to initiate the channel change procedure via the channel change intention message, as described above.

### BRIEF DESCRIPTION OF THE DRAWINGS

A more detailed understanding of the invention may be had from the following description of a preferred embodiment, given by way of example, and to be understood in conjunction with the accompanying drawings, wherein:

FIG. 1 is a flowchart of a method for seamless channel change initiated by an AP in accordance with the present invention;

FIG. 2 is a signal flow diagram of the method shown in FIG. 1; and

FIG. 3 is a flowchart of a method for seamless channel change initiated by a STA in accordance with the present invention.

### DETAILED DESCRIPTION OF THE PREFERRED EMBODIMENTS

Hereafter, the term “station” (STA) includes, but is not limited to, a wireless transmit/receive unit, a user equipment, a fixed or mobile subscriber unit, a pager, or any other type of device capable of operating in a wireless environment. When referred to hereafter, the term “access point” (AP) includes, but is not limited to, a base station, a Node B, a site controller, or any other type of interfacing device in a wireless environment.

The present invention solves the problem described above by setting up a hand-shaking procedure between an AP and a STA in which the AP communicates to its associated STAs its intention to switch channels and by which the STA acknowledges that it will or will not follow the AP on the new channel. This procedure ensures that all STAs are aware of the AP's intention to change the channel and that the AP is aware of which STAs are able to follow to the new channel and which STAs would have followed to the new channel had the AP decided to go forward with the channel change. The present invention also solves the problem by allowing the STA to request a channel change, thus triggering the hand-shaking procedure.

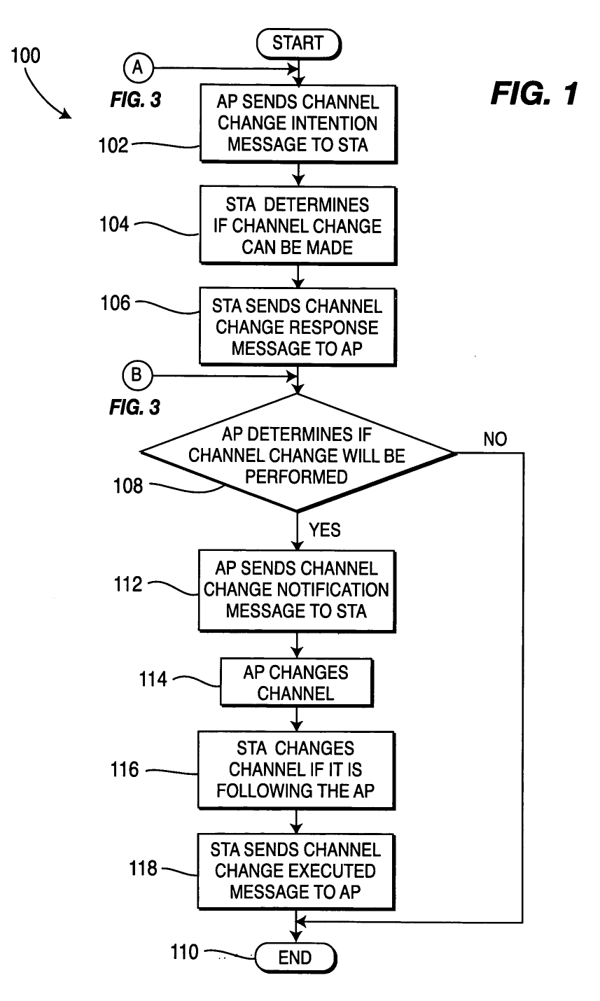

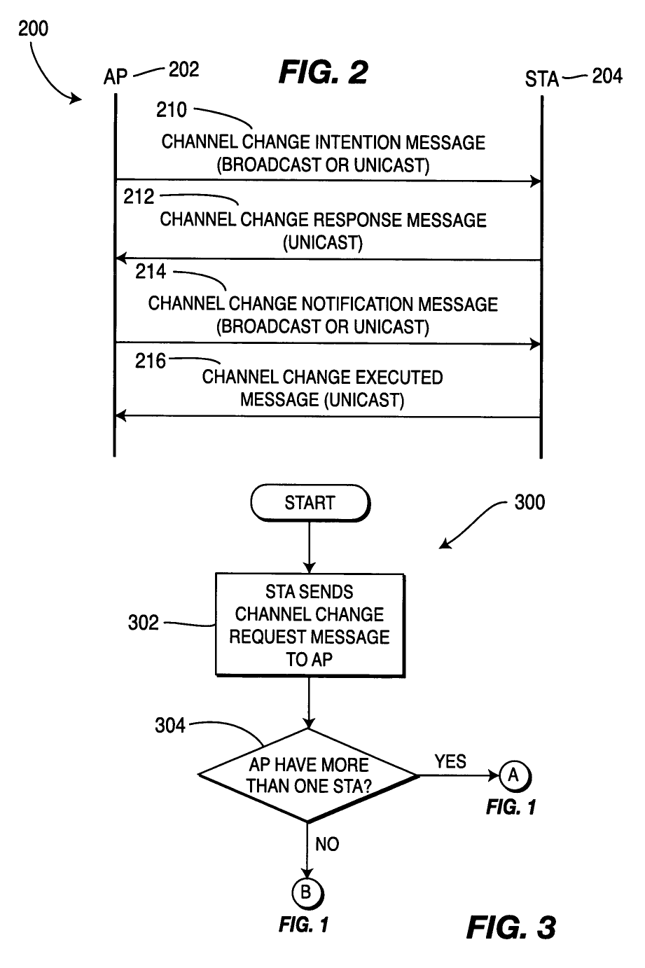

The AP initiated hand-shaking procedure 100 of the present invention is illustrated in FIG. 1. For purposes of simplifying the drawings and the discussion of the invention, the following description only refers to a single STA. The principles of the present invention can be equally applied to a system which has multiple STAs.

An AP sends a STA a channel change intention message indicating its intention to change its channel to channel X, where X represents a channel identifier (step 102). The message also contains information relative to the timing of the channel change. This message can be sent using a broadcast frame or a unicast frame. The advantage of using a broadcast frame is that it limits the number of messages sent over the wireless medium when multiple STAs are associated to the AP. The advantage of using a unicast frame (one for each associated STA) is that it tends to increase the robustness of the signaling, since the AP expects a MAC ACK from the STA indicating whether or not the STA has correctly received the message. In the case where no ACK is received from a certain STA, the AP can re-send the channel change intention message.

Upon reception of the channel change intention message, the STA determines if it will change its channel to the new channel based on its capabilities, the radio frequency environment it perceives from its location, and the availability and load of other APs in the system (step 104). This determination involves a multiple criteria decision-making process. For example, the first criterion the STA could consider is whether it has the capabilities (considering hardware and configuration limitations) to change to channel X, as announced in the channel change intention message sent by the AP. The second and third criteria the STA is likely to consider include the level of interference and load the STA perceives on channel X. Based on such criteria, the STA decides whether the channel change is desirable or not. This conclusion can be reached using any form of multiple criteria analysis that compares scores obtained from a weight-based calculation against predetermined levels.

Once the decision is made, the STA sends a channel change response message which includes a notification that the message was received (applicable in the case where the channel change intention message is sent using a broadcast), and an indication as to whether or not the STA will follow the AP to its new channel (step 106).

The indication in the channel change response message contains various pre-defined responses including, but not limited to:

1) The STA will follow the AP to the new channel.

2) The STA will not follow to the new channel and would like to continue to be served by the AP on the same channel. This situation could arise if the STA's scanning indicates that the new channel will degrade its performance, if the STA lacks the capabilities to change channels, or if the STA determines that changing the channel will not allow it to satisfy the QoS requirements of the user's application.

3) The STA will not follow the AP to the new channel but does not request the AP to stay on the same channel. This situation could arise if the STA has identified another candidate AP which it determines can offer better performance than the current AP on the new channel.

The range of techniques by which a STA could perform the channel change determination include using measured or reported quality metrics (e.g., signal to noise ratio (SNR), signal to interference and noise ratio (SINR), packet error rate (PER), etc.) on the new channel and comparing these metrics to quality metrics measured on the current channel or to predetermined levels. The STA could also use measured or reported load metrics (e.g., channel occupancy, medium access delay, etc.) on the new channel and compare them to load metrics measured on the current channel or to predetermined levels. It is also possible to use weight-based combinations of several of the above metrics obtained on the new channel, to be compared against the same metrics obtained on the current channel or against predetermined levels.

If the AP sends its channel change intention message using a broadcast, the channel change response message sent by the STA will also serve the purpose of acknowledging the reception of the channel change intention message. There are some advantages in sending the channel change intention message as a unicast message (which commands for an ACK), since it allows the AP to discriminate between a STA that did not receive the channel change intention message and a STA that received the channel change intention message but did not send the channel change response message. The AP waits for all responses from all STAs (positive or negative) or until a timeout occurs, and then makes the decision whether it will go forward or not with the channel change. The AP is not bound to do what the STA suggested.

Based on the channel change response notification received from the STA, the AP then makes a decision whether it is going to change the channel or not (step 108). This step allows the AP to reconsider its intention to change the channel. For example, in the case where the AP only serves a single STA and this STA indicates that it cannot follow the AP to the new channel, the AP might decide not to perform the channel change. This is also an opportunity for the AP to request measurements from the STAs if it believes that measurement reports will help it to make a better decision.

In general, the determination of whether or not the AP will go forward with the channel change is based on the relative number of users that have responded with each type of channel change message versus the foreseen impact on quality of service of not performing the channel change. A decision making process which compares the relative number of responses of each type against targets that vary according to the foreseen performance gain of switching the channel is one of several potential implementations.

If the AP decides not to change channels, the procedure 100 terminates (step 110). In the event that the AP decides to go forward with the channel change (step 108), it then sends a channel change notification message to the associated STA (step 112). The message also contains information relative to the timing of the channel change. This message can be sent using a broadcast frame or a unicast frame, with the advantages of each type of frame being the same as described above.

If the AP decides to go forward with the channel change, it can use the information contained in the channel change response message received from the STA and remove all the buffered packets dedicated to the STA that responded that it would not follow the AP to the new channel. This prevents the AP from wasting a considerable amount of bandwidth by unsuccessfully transmitting packets to the STA if it has not followed the AP to the new channel. The AP changes to the new channel (step 114) and the STA changes to the new channel if it is following the AP (step 116).

An optional step for the hand-shaking procedure is to have the STA send the AP a channel change executed message after it has changed the channel (step 118). This information could also be used to prevent the AP from wasting bandwidth by unsuccessfully transmitting packets to a STA that would have indicated (in its channel change response message) that it would follow the AP to the new channel but that would have failed to do so. The procedure then terminates (step 110).

FIG. 2 is a signal diagram of a system 200 executing the procedure shown in FIG. 1. The system 200 includes an AP 202 and a STA 204. The AP 202 sends a channel change intention message 210, which can be sent as a broadcast or as a unicast. The STA 204 (or each STA 204 if the AP 202 has multiple STAs associated to it) responds to the intention message 210 by sending a channel change response message 212 to the AP 202. Each STA 204 sends its response message as a unicast message.

If the channel change is going to occur, the AP 202 sends a channel change notification message 214 to the STA 204. As with the intention message 210, the notification message 214 can be sent as a broadcast or a unicast message. As an optional last message, the STA 204 can send a channel change executed message 216 to the AP 202 upon a successful channel change.

A method 300 in accordance with the present invention by which a STA requests the AP to change its channel is shown in FIG. 3. In a preferred embodiment, the present invention enables the STA to request the AP to change the channel it uses. The need for such a request may arise when the interference or channel activity perceived by the STA is such that it jeopardizes the QoS perceived by its user.

The STA sends a change channel request message as a unicast frame to its AP (step 302). The message can include some or all of the following information: time limit for performing the channel change, list of preferred channels on which to migrate to, and interference or noise level measurements on the current and candidate channels.

Upon reception of this message, the AP can then take one of two actions. If the AP has multiple STAs associated to it, it could perform the AP initiated hand-shaking procedure 100, beginning at step 102. If the AP only has a single STA associated with it, it could decide to go forward with the channel change procedure, and perform the procedure 100 beginning at step 108.

At any point in the flow of events described in FIG. 1, the AP can take measurements on the current and proposed channels and/or ask for measurements from the STA requesting the channel change.

Exemplary applications of the present invention include the areas of load balancing and dynamic channel selection. In these applications, it is desirable for the AP to change its channel in order to adapt to time-varying load and interference conditions. The present invention allows for such channel changes to be performed with minimal service interruption for associated STAs.

Although the features and elements of the present invention are described in the preferred embodiments in particular combinations, each feature or element can be used alone (without the other features and elements of the preferred embodiments) or in various combinations with or without other features and elements of the present invention. While specific embodiments of the present invention have been shown and described, many modifications and variations could be made by one skilled in the art without departing from the scope of the invention. The above description serves to illustrate and not limit the particular invention in any way.

What is claimed is:

1. A method for seamless channel change in a wireless local area network (WLAN) having a station (STA) and an access point (AP), the method comprising the steps of:
sending a channel change intention message from the AP to the STA;
sending a channel change response message from the STA to the AP, informing the AP whether the STA will follow the channel change;
determining at the AP whether to proceed with the channel change; and
performing a channel change if the determination is positive.

2. The method according to claim 1, wherein the channel change response message includes an acknowledgement that the channel change intention message was received.

3. The method according to claim 1, wherein the performing step includes:
sending a channel change notification message from the AP to the STA;
changing the channel at the AP and at the STA; and
sending a channel change executed message from the STA to the AP upon successful execution of the channel change.

4. The method according to claim 1, wherein the WLAN includes more than one STA and the performing step considers the number of STAs that can change channels prior to executing the channel change.

5. A method for seamless channel change in a wireless local area network (WLAN) having a station (STA) and an access point (AP), the method comprising the steps of:
sending a channel change request message from the STA to the AP;
determining whether the channel change can be performed; and
performing the channel change based on the determination.

6. The method according to claim 5, wherein the WLAN includes only one STA and the determining step includes:
deciding whether the channel change will be performed by the AP;
sending a channel change notification message from the AP to the STA if the channel change is to be performed; and
changing the channel at the AP and at the STA.

7. The method according to claim 6, further comprising the step of:
sending a channel change executed message from the STA to the AP if the channel change has been successfully completed.

8. The method according to claim 5, wherein the WLAN includes more than one STA and the determining step includes
sending a channel change intention message from the AP to each STA;
deciding whether the channel change can be supported by each STA;
sending a channel change response message from each STA to the AP;
deciding whether the channel change will be performed by the AP;
sending a channel change notification message from the AP to each STA if the channel change is to be performed; and
changing the channel at the AP and at each STA.

9. The method according to claim 8, further comprising the step of:
sending a channel change executed message from each STA to the AP if the channel change has been successfully completed.

10. A system for performing a seamless channel change in a wireless local area network (WLAN), comprising:
an access point (AP);
a station (STA);
said AP configured to send a channel change intention message to said STA;
said STA configured to send a channel change response message to said AP, said channel change response message including an indication whether said STA will follow said AP to a new channel; and
said AP configured to determine whether to change its channel after receiving said channel change response message and to change its channel if the determination is positive.

11. The system according to claim 10, wherein said channel change response message includes an acknowledgement that said channel change intention message was received by said STA.

12. The system according to claim 10, wherein if said AP determines to change its channel, then:
said AP is further configured to send a channel change notification message to said STA and to change its channel; and
said STA is further configured to change its channel and to send a channel change executed message to said AP upon successful execution of the channel change.

13. The system according to claim 10, wherein the WLAN includes more than one STA and said AP considers the number of STAs that can change channels prior to executing the channel change.

14. A system for performing a seamless channel change in a wireless local area network (WLAN), comprising:
an access point (AP);
a station (STA);
said STA configured to send a channel change request message to said AP; and
said AP configured to determine whether the channel change can be performed and to perform the channel change based on the determination.

15. The system according to claim 14, wherein
the WLAN includes only one STA;
said AP sends a channel change notification message to said STA if the channel change is to be performed;
said AP is configured to change its channel; and
said STA is configured to change its channel.

16. The system according to claim 15, wherein said STA is further configured to send a channel change executed message to said AP if the channel change has been successfully completed.

17. The system according claim 14, wherein
the WLAN includes more than one STA;
said AP is configured to send a channel change intention message to each STA;
each STA is configured to determine whether the channel change can be supported and to send a channel change response message to said AP;
said AP is configured to determine whether the channel change will be performed, to send a channel change notification message to each STA if the channel change will be performed, and to change its channel; and
each STA is configured to change its channel.

18. The system according to claim 17, wherein each STA is further configured to send a channel change executed message to said AP if the channel change has been successfully completed.
